(19) United States
(12) Patent Application Publication
(10) Pub. No.: US 2025/0258362 A1
(43) Pub. Date: Aug. 14, 2025

(54) OPTICAL SYSTEM AND IMAGE PICKUP APPARATUS

(71) Applicant: CANON KABUSHIKI KAISHA, Tokyo (JP)

(72) Inventor: Yasuaki HAGIWARA, Tochigi (JP)

(21) Appl. No.: 18/985,111

(22) Filed: Dec. 18, 2024

(30) Foreign Application Priority Data
Feb. 14, 2024 (JP) 2024-019947

(51) Int. Cl. G02B 13/26; G02B 13/18

(52) U.S. Cl. CPC G02B 13/26; G02B 13/18

(57) ABSTRACT

An optical system includes a front lens unit, a first focus lens unit disposed on an image side of the front lens unit, and a second focus lens unit disposed on the image side of the first focus lens unit. A distance between adjacent lens units changes during focusing. The front lens unit includes two or more negative lenses. For focusing, the front lens unit does not move, but the first focus lens unit and the second focus lens unit move. The optical system can provide focusing from an in-focus state on an object at infinity to an in-focus state in which lateral magnification β of the optical system is −1.0 or less. A predetermined inequality is satisfied.

### BACKGROUND

### Technical Field The present disclosure relates to an optical system usable for macro imaging.

### Description of Related Art

Wide-angle optical systems (macro lenses) for short-distance (macro) imaging include those disclosed, for example, in Japanese Patent Laid-Open Nos. 2009-139416 and 2012-220828.

### SUMMARY

An optical system according to one aspect of the disclosure includes a front lens unit, a first focus lens unit disposed on an image side of the front lens unit, and a second focus lens unit disposed on the image side of the first focus lens unit. A distance between adjacent lens units changes during focusing. The front lens unit includes two or more negative lenses. For focusing, the front lens unit does not move, but the first focus lens unit and the second focus lens unit move. The optical system can provide focusing from an in-focus state on an object at infinity to an in-focus state in which lateral magnification β of the optical system is −1.0 or less. The following inequality is satisfied:

$$- 5.5 \; 00 \leq \vert ffr \vert / f 1 \leq 0.38$$

where f1 is a focal length of the front lens unit, and ffr is a focal length of at least one of the first focus lens unit and the second focus lens unit. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a sectional view of an optical system according to Example 1.

FIG. 2A illustrates an aberration diagram of the optical system according to Example 1 in an in-focus state at infinity, and FIG. 2B illustrates an aberration diagram of the optical system according to Example 1 in an in-focus state at the closest distance.

FIG. 3 illustrates a sectional view of an optical system according to Example 2.

FIG. 4A illustrates an aberration diagram of the optical system according to Example 2 in an in-focus state at infinity, and FIG. 4B illustrates an aberration diagram of the optical system according to Example 2 in an in-focus state at the closest distance.

FIG. 5 illustrates a sectional view of an optical system according to Example 3.

FIG. 6A illustrates an aberration diagram of the optical system according to Example 3 in an in-focus state at infinity, and FIG. 6B illustrates an aberration diagram of the optical system according to Example 3 in an in-focus state at the closest distance.

FIG. 7 illustrates a sectional view of an optical system according to Example 4.

FIG. 8A illustrates an aberration diagram of the optical system according to Example 4 in an in-focus state at infinity, and FIG. 8B illustrates an aberration diagram of the optical system according to Example 4 in an in-focus state at the closest distance.

FIG. 9 illustrates a lateral aberration diagram of the optical system according to Example 1 in an image stabilizing state.

FIG. 10 schematically illustrates an image pickup apparatus having the optical systems according to any one according to Examples 1 to 4.

### DETAILED DESCRIPTION

Each example will now be described with reference to the drawings. Prior to a detailed description of each of Examples 1 to 4, matters common to each example will be described. An optical system according to each example is used as an imaging optical system for various image pickup apparatuses such as digital still cameras, video cameras, security cameras, and on-board (in-vehicle) cameras.

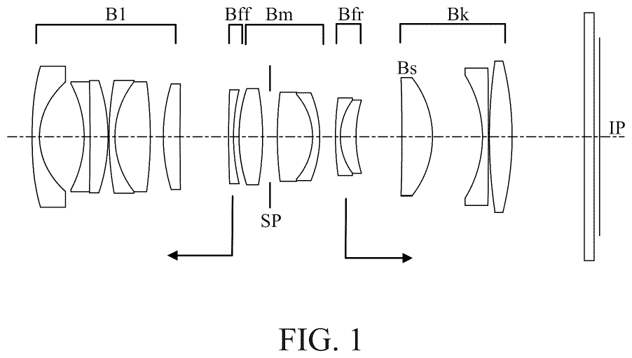

FIGS. 1, 3, 5, and 7 illustrate sections of optical systems according to Examples 1 to 4, respectively. The optical system according to each example includes, in order from the object side to the image side, a front lens unit B1 that does not move for focusing, a first focus lens unit Bff that moves for focusing, an intermediate lens unit Bm that does not move for focusing, a second focus lens unit Bfr that moves for focusing, and a rear lens unit Bk that does not move for focusing. The lens unit is a group of one or more lenses that may or may not integrally move during focusing between an in-focus state on an object at infinity (referred to as “in an in-focus state at infinity” hereinafter) and an in-focus state on an object at the closest distance (referred to as “in an in-focus state at the closest distance” hereinafter). That is, a distance between adjacent lens units changes during focusing.

The optical system according to each example can perform focusing from the in-focus state at infinity to a state in which the lateral magnification β of the optical system is −1.0 or less. That is, the optical system can support imaging in a range from infinity to so-called same-size or life-size macro imaging. In the following description, the first focus lens unit is abbreviated to a first focus unit, and the second focus lens unit is abbreviated to a second focus unit.

The optical system according to each example includes an aperture stop SP in the intermediate lens unit Bm. IP represents an image plane. An imaging surface (light receiving surface) of an image sensor such as a CCD sensor or a CMOS sensor, or a film surface (photosensitive surface) of a silver film is disposed on the image plane IP.

In order to achieve high optical performance even during macro imaging, the optical system according to each example may satisfy the following inequality (1):

$$- 5.5 \; 00 \leq \vert ffr \vert / f 1 \leq 0.380 \qquad ( 1 )$$

where f1 is a focal length of the front lens unit B1, and ffr is a focal length of at least one of the first focus unit and the second focus unit.

Inequality (1) defines a proper relationship between the focal length ffr (absolute value) of at least one of the first and second focus units and the focal length f1 of the front lens unit. In a case where the focal length of at least one of the focus units increases so that |ffr|/f1 becomes higher than the upper limit of inequality (1), aberrational correction becomes easier, but a moving amount of the at least one of the first and second focus units during focusing increases, and it becomes difficult to reduce the size of the optical system. In a case where the focal length of at least one of the focus units reduces so that |ffr//f1 becomes lower than the lower limit of inequality (1), it is effective for reducing the size of the optical system, but it becomes difficult to correct spherical aberration during focusing.

Inequality (1) may be replaced with inequality (1a) below:

$$- 4.5 \; 00 \leq \vert ffr \vert / f 1 \leq 0.370 \qquad ( 1 a )$$

Inequality (1) may be replaced with inequality (1b) below:

$$- 4.0 \; 00 \leq \vert ffr \vert / f 1 \leq 0.360 \qquad ( 1 b )$$

Satisfying the above configurations and inequalities can achieve an optical system that has a wide angle, a reduced size, a high image magnification, a bright F-number, and high optical performance, and can support autofocus (AF) and optical image stabilization.

The optical system according to each example may satisfy at least one of the inequalities and configurations of the following inequalities (2) to (14).

The optical system according to each example may satisfy the following inequality (2):

$$1. 3 \; 40 \leq \vert ff \vert / f \leq 6.370 \qquad ( 2 )$$

where ff is a focal length of the first focus unit, and fis a focal length of the optical system in an in-focus state at infinity.

Inequality (2) defines a proper relationship between the focal length ff (absolute value) of the first focus unit and the focal length f of the optical system. In a case where the focal length of the first focus unit increases so that |ff/f becomes higher than the upper limit of inequality (2), aberrational correction becomes easier, but a moving amount of the first focus unit during focusing increases, and it becomes difficult to reduce the size of the optical system. In a case where the focal length of the first focus unit reduces so that |ff|/f becomes lower than the lower limit of inequality (2), it is effective for reducing the size of the optical system, but it becomes difficult to correct curvature of field during focusing.

The optical system according to each example may satisfy the following inequality (3):

$$- 1.5 \leq \vert dltf \vert / d 1 \leq 0.8 \qquad ( 3 )$$

where dltf is a moving amount of the first focus unit during focusing from infinity to the closest surface, and d1 is a thickness of the front lens unit (a length on the optical axis from a surface closest to an object to a surface closest to the image plane).

A moving amount of the focus unit is a difference between a position of the focus unit in an in-focus state at infinity and a position of the focus unit in an in-focus state at the closest distance, and does not include a reciprocating moving amount, and is positive when the focus unit is located closer to the image side in an in-focus state at the closest distance than in an in-focus state at infinity.

Inequality (3) defines a proper relationship between the moving amount dltf (absolute value) of the first focus unit during focusing from infinity to the closest distance, and the thickness d1 of the front lens unit.

In a case where the moving amount of the first focus unit increases so that |dltf|/dl becomes higher than the upper limit of inequality (3), it is difficult to reduce the size of the optical system. In a case where the moving amount of the first focus unit reduces so that |dltf|/d1 becomes lower than the lower limit of inequality (3), the size of the optical system can be reduced, but the fluctuation in spherical aberration during focusing increases.

The optical system according to each example may satisfy inequality (4) below:

$$0.06 \leq \vert dltr \vert / d 1 \leq 2. \qquad ( 4 )$$

where dltr is a moving amount of the second focus unit during focusing from infinity to the closest distance, and dl is a thickness of the front lens unit.

Inequality (4) defines a proper relationship between the moving amount dltr (absolute value) of the second focus unit and the thickness d1 of the front lens unit during focusing from infinity to the closest distance.

In a case where the moving amount of the second focus unit increases so that |dltr|/d1 becomes higher than the upper limit of inequality (4), it is difficult to reduce the size of the optical system. In a case where the moving amount of the second focus unit reduces so that |dltr/d1 becomes lower than the lower limit of inequality (4), the size of the optical system can be reduced, but the fluctuation in spherical aberration during focusing increases.

The optical system according to each example may satisfy inequality (5) below:

$$0.02 \leq df / f \leq 0.4 \qquad ( 5 )$$

where df is a thickness of the first focus unit (a length on the optical axis from a surface closest to an object to a surface closest to the image plane) and fis a focal length of the optical system in an in-focus state at infinity.

Inequality (5) defines a proper relationship between the thickness df of the first focus unit and the focal length f of the optical system. In a case where the thickness of the first focus unit increases so that df/f becomes higher than the upper limit of inequality (5), it becomes difficult to secure a moving amount of the first focus unit during focusing and the size reduction of the optical system becomes difficult. In a case where the thickness of the first focus unit reduces so that df/f becomes lower than the lower limit of inequality (5), the size of the optical system can be reduced, but deformation, etc., is likely to occur during processing of the lenses of the first focus unit, and the optical performance is likely to fluctuate.

The optical system according to each example may satisfy inequality (6) below:

$$0.09 \leq dr / f \leq 0.500 \qquad ( 6 )$$

where dr is a thickness of the second focus unit (a length on the optical axis from a surface closest to an object to a surface closest to the image plane), and f is a focal length of the optical system in an in-focus state at infinity.

Inequality (6) defines a proper relationship between the thickness of the second focus unit and the focal length of the optical system. In a case where the thickness of the second focus unit increases so that dr/f becomes higher than the upper limit of inequality (6), it becomes difficult to secure a moving amount of the second focus unit during focusing and it becomes difficult to reduce the size of the optical system. In a case where the thickness of the second focus unit reduces so that dr/f becomes lower than the lower limit of inequality (6), the size of the optical system can be reduced, but deformation and the like are likely to occur during processing of the lenses of the second focus unit, and the optical performance is more likely to fluctuate.

The optical system according to each example may satisfy inequality (7) below:

$$0.06 \leq \vert f 1 \vert / sk \leq 23.100 \qquad ( 7 )$$

where f1 is a focal length of the front lens unit, and sk is the back focus of the optical system (an air-equivalent distance from a surface closest to the image plane to the paraxial image plane).

Inequality (7) defines a proper relationship between the focal length f1 (absolute value) of the front lens unit and the back focus sk. In a case where the focal length of the front lens unit increases so that |f1|/sk becomes higher than the upper limit of inequality (7), aberrational correction becomes easier, but the overall length of the optical system increases, and the size reduction becomes difficult. In a case where the focal length of the front lens unit reduces so that |f1|/sk becomes lower than the lower limit of inequality (7), the size of the optical system can be reduced, but it becomes difficult to correct spherical aberration.

The optical system according to each example may satisfy inequality (8) below:

$$- 3.2 \leq \vert ff \vert / \vert fr \vert \leq 1.7 \qquad ( 8 )$$

where ff is a focal length of the first focus unit, and fr is a focal length of the second focus unit.

Inequality (8) defines a proper relationship between the focal length ff (absolute value) of the first focus unit and the focal length fr (absolute value) of the second focus unit. In a case where the focal length of the first focus unit increases so that |ff|/|fr| becomes higher than the upper limit of inequality (8), aberrational correction becomes easier, but a moving amount of the first focus unit during focusing increases and it becomes difficult to reduce the size of the optical system. In a case where the focal length of the first focus unit reduces so that |ff|/|fr| becomes lower than the lower limit of inequality (8), the size of the optical system can be reduced, but it becomes difficult to correct spherical aberration.

In the optical system according to each example, the intermediate lens unit Bm disposed on the image side of the first focus unit may not move during focusing, include an aperture stop SP and an aspherical lens, and have positive refractive power overall. This configuration allows for good correction of spherical aberration.

The optical system according to each example may satisfy the following inequality (9):

$$0.05 \leq fm / \vert f 1 \vert \leq 1. \qquad ( 9 )$$

where fm is a focal length of the intermediate lens unit, and f is a focal length of the front lens unit.

Inequality (9) defines a proper relationship between the focal length fm of the intermediate lens unit and the focal length f1 (absolute value) of the front lens unit. In a case where the focal length of the intermediate lens unit increases so that fm/|f1| becomes higher than the upper limit of inequality (9), aberrational correction becomes easier, but the overall length of the optical system increases and it becomes difficult to reduce the size of the optical system. In a case where the focal length of the intermediate lens unit reduces so that fm/|f1| becomes lower than the lower limit of inequality (9), the size of the optical system can be reduced, but it becomes difficult to correct spherical aberration.

The optical system according to each example may satisfy the following inequality (10):

$$0. 440 \leq fm / f \leq 8.4 \qquad ( 10 )$$

where fm is a focal length of the intermediate lens unit, and fis a focal length of the optical system in the in-focus state at infinity.

Inequality (10) defines a proper relationship between the focal length fm of the intermediate lens unit and the focal length f of the optical system. In a case where the focal length of the intermediate lens unit increases so that fm/f becomes higher than the upper limit of inequality (10), aberrational correction becomes easier, but the overall length of the optical system increases and it becomes difficult to reduce the size of the optical system. In a case where the focal length of the intermediate lens unit reduces so that fm/f becomes lower than the lower limit of inequality (10), the size of the optical system can be reduced, but it becomes difficult to correct spherical aberration.

The optical system according to each example may satisfy the following inequality (11):

$$0.120 \leq fm / \vert fr \vert \leq 0. 800 \qquad ( 11 )$$

where fm is a focal length of the intermediate lens unit, and fr is a focal length of the second focus unit.

Inequality (11) defines a proper relationship between the focal length fm of the intermediate lens unit and the focal length fr (absolute value) of the second focus unit. In a case where the focal length of the intermediate lens unit increases so that fm/|fr| becomes higher than the upper limit of inequality (11), aberrational correction becomes easier, but the overall length of the optical system increases and it becomes difficult to reduce the size of the optical system. In a case where the focal length of the intermediate lens unit reduces so that fm/|fr| becomes lower than the lower limit of inequality (11), the size of the optical system can be reduced, but it becomes difficult to correct spherical aberration.

In the optical system according to each example, the rear lens unit Bk that is disposed on the image side of the second focus unit and does not move during focusing may have positive or negative refractive power, and include an aspheric lens. This configuration allows for good correction of curvature of field and lateral chromatic aberration.

The optical system according to each example may satisfy the following inequality (12):

$$0.1 \; 50 \leq \vert fk \vert / \vert f 1 \vert \leq 6. 900 \qquad ( 12 )$$

where fk is a focal length of the rear lens unit, and f1 is a focal length of the front lens unit.

Inequality (12) defines a proper relationship between the focal lengths fk (absolute value) and f1 (absolute value) of the rear lens unit and the front lens unit. In a case where the focal length of the rear lens unit increases so that |fk|/|f1| becomes higher than the upper limit of inequality (12), aberrational correction becomes easier, but the back focus increases, and it becomes difficult to reduce the size of the optical system. In a case where the focal length of the rear lens unit reduces so that |fk|/|f1| becomes lower than the lower limit of inequality (12), the size of the optical system can be reduced, but it becomes difficult to correct lateral chromatic aberration.

The optical system according to each example may satisfy inequality (13) below:

$$0. 4 \; 90 \leq \vert fk \vert / f \leq 4.500 \qquad ( 13 )$$

where fk is a focal length of the rear lens unit, and f1 is a focal length of the optical system in an in-focus state at infinity.

Inequality (13) defines a proper relationship between the focal length fk (absolute value) of the rear lens unit and the focal length f of the optical system. In a case where the focal length of the rear lens unit increases so that |fk|/f becomes higher than the upper limit of inequality (13), aberrational correction becomes easier, but the back focus increases and it becomes difficult to reduce the size of the optical system. In a case where the focal length of the rear lens unit reduces so that |fk|/f becomes lower than the lower limit of inequality (13), the size of the optical system can be reduced, but it becomes difficult to correct lateral chromatic aberration.

The optical system according to each example may satisfy inequality (14):

$$0.61 \leq \vert fk \vert / \vert ff \vert \leq 4. \qquad ( 14 )$$

where fk is a focal length of the rear lens unit, and ff is a focal length of the second focus unit.

Inequality (14) defines a proper relationship between the focal length fk (absolute value) of the rear lens unit and the focal length ff (absolute value) of the second focus unit. In a case where the focal length of the rear lens unit increases so that |fk|/|ff| becomes higher than the upper limit of inequality (14), aberrational correction becomes easier, but the back focus increases and it becomes difficult to reduce the size of the optical system. In a case where the focal length of the rear lens unit becomes too short so that |fk|/|ff| becomes lower than the lower limit of inequality (14), the size of the optical system can be reduced, but it becomes difficult to correct lateral chromatic aberration.

In the optical system according to each example, each of the first focus unit Bff and the second focus unit Bfr may include two or less lenses. This configuration can reduce the size of the focus mechanism that drives each focus unit during autofocusing.

The optical system according to each example may move (shift) all or a part of the intermediate lens unit Bm in a direction that includes a directional component perpendicular to the optical axis for optical image stabilization. Since the intermediate lens unit is a lens unit with a relatively small diameter in the optical system, shifting at least a part of the lenses thereof by the image stabilizing mechanism can easily reduce the size of the optical system including the image stabilizing mechanism.

In the optical system according to each example, a lens closest to an object among the rear lens unit Bk may be shifted for optical image stabilization. The lens closest to the object among the rear lens unit Bk has a relatively small diameter in the optical system, so by shifting it using the image stabilizing mechanism, the size of the optical system including the image stabilizing mechanism can be easily reduced.

The optical system according to each example may have a five-unit configuration including, in order from the object side to the image side, a front lens unit B1 with positive or negative refractive power, a first focus unit Bff with negative refractive power, an intermediate lens unit Bm with positive refractive power including an aperture stop SP, a second focus unit Bfr with negative or positive refractive power, and a rear lens unit Bk with negative or positive refractive power. Thereby, the size of the optical system can be reduced while various aberrations can be satisfactorily corrected.

Inequalities (2) to (14) may be replaced with inequalities (2a) to (14a) below:

$$1.61 \leq \vert ff \vert / f \leq 5.31 \qquad ( 2 a )$$

$$- 1.36 \leq \vert dltf \vert / d 1 \leq 0.62 \qquad ( 3 a )$$

$$0.07 \leq \vert dltr \vert / d 1 \leq 1.6 \qquad ( 4 a )$$

$$0.03 \leq df / f \leq 0.29 \qquad ( 5 a )$$

$$0.11 \leq dr / f \leq 0.410 \qquad ( 6 a )$$

$$0.8 \leq \vert f 1 \vert / sk \leq 19.21 \qquad ( 7 a )$$

$$- 2.95 \leq \vert ff \vert / \vert fr \vert \leq 1.35 \qquad ( 8 a )$$

$$0.07 \leq fm / \vert f 1 \vert \leq 0.81 \qquad ( 9 a )$$

$$0.53 \leq fm / f \leq 6.980 \qquad ( 10 a )$$

$$0.14 \leq fm / \vert fr \vert \leq 0. 630 \qquad ( 11 a )$$

$$0.18 \leq \vert fk \vert / \vert f 1 \vert \leq 5.7 \qquad ( 12 a )$$

$$0.59 \leq \vert fk \vert / f \leq 3.73 \qquad ( 13 a )$$

$$0.73 \leq \vert fk \vert / \vert ff \vert \leq 3.32 \qquad ( 14 a )$$

Inequalities (2) to (14) may be replaced with inequalities (2b) to (14b) below:

$$1.83 \leq \vert ff \vert / f \leq 4.670 \qquad ( 2 b )$$

$$- 1.18 \leq \vert dltf \vert / d 1 \leq 0.55 0 \qquad ( 3 b )$$

$$0.08 \leq \vert dltr \vert / d 1 \leq 1.4 \qquad ( 4 b )$$

$$0.03 \leq df / f \leq 0.25 \qquad ( 5 b )$$

$$0.12 \leq dr / f \leq 0.36 \qquad ( 6 b )$$

$$0.91 \leq \vert f 1 \vert / sk \leq 16.9 \qquad ( 7 b )$$

$$- 2.63 \leq \vert ff \vert / \vert fr \vert \leq 1.19 \qquad ( 8 b )$$

$$0.08 \leq fm / \vert f 1 \vert \leq 0.710 \qquad ( 9 b )$$

$$0.6 \leq fm / f \leq 6.14 \qquad ( 10 b )$$

$$0.16 \leq fm / \vert fr \vert \leq 0.56 \qquad ( 11 b )$$

$$0.21 \leq \vert fk \vert / \vert f 1 \vert \leq 5.02 \qquad ( 12 b )$$

$$0.679 \leq \vert fk \vert / f \leq 3.28 \qquad ( 13 b )$$

$$0.83 \leq \vert fk \vert / \vert ff \vert \leq 2.92 \qquad ( 14 b )$$

A detailed description will now be given of Examples 1 to 4 along with corresponding numerical examples 1 to 4. In each numerical example, a surface number i indicates the order of the surface counted from the object side. r represents a radius of curvature (mm) of an i-th surface counted from the object side, d represents a lens thickness or air gap (mm) on the optical axis between i-th and (i+1)-th surfaces, and nd is a refractive index for the d-line of an optical material between i-th and (i+1)-th surfaces. vd is an Abbe number based on the d-line of the optical material between i-th and (i+1)-th surfaces.

The Abbe number vd based on the d-line is expressed as:

$$v d = ( N d - 1 ) / ( NF - NC )$$

where Nd, NF, and NC are refractive indices for the d-line (587.6 nm), F-line (486.1 nm), and C-line (656.3 nm) in the Fraunhofer lines.
β is an imaging magnification in paraxial calculations, and here indicates the lateral magnification (−1.0) of the optical system in an in-focus state at the closest distance. f represents a focal length, Fno represents an F-number, @ represents a half angle of view (°) and sk represents the back focus (mm). As mentioned above, the back focus is a distance on the optical axis from a lens surface closest to the image plane (final surface) of the optical system to the paraxial image plane, expressed in air-equivalent length. The overall lens length is a distance on the optical axis from a lens surface closest to an object to a final surface of the optical system plus the back focus.

An asterisk “*” next to a surface number means that the surface has an aspheric shape. The aspheric shape is expressed by the following equation:

$$X = \frac{{H}^{2} / R}{1 + \sqrt{1 - ( 1 + K ) {( H / R )}^{2}}} + A 4 {H}^{4} + A 6 {H}^{6} + A 8 {H}^{8} + A 10 {H}^{10} + A 12 {H}^{12}$$

where X is a displacement amount from a surface vertex in the optical axis direction, His a height from the optical axis in a direction perpendicular to the optical axis, a light traveling direction is positive, R is a paraxial radius of curvature, K is a conic constant, and A4, A6, A8, A10, and A12 are aspheric coefficients. The “e±x” in the conic constant and aspheric coefficient means×10^{±x}.

Table 1 summarizes values corresponding to inequalities (1) to (14) in numerical examples 1 to 4. Each numerical example satisfies all of the inequalities (1) to (14).

### EXAMPLE 1

An optical system according to Example 1 (numerical example 1) illustrated in FIG. 1 includes, in order from the object side to the image side, a front lens unit (first lens unit) B1 with negative refractive power, a first focus unit (second lens unit) Bff with negative refractive power, an intermediate lens unit (third lens unit) Bm with positive refractive power, a second focus unit (fourth lens unit) Bfr with negative refractive power, and a rear lens unit (fifth lens unit) Bk with positive refractive power. During focusing from infinity to the closest distance, the first focus unit Bff and the second focus unit Bfr move toward the object side and the image side, respectively, as illustrated by arrows in FIG. 1.

The shift lens Bs of the rear lens unit Bk closest to an object shifts relative to the optical axis for optical image stabilization while suppressing chromatic aberration fluctuation. Optical image stabilization is also performed by shifting a cemented lens on the image side of the aperture stop SP in the intermediate lens unit Bm relative to the optical axis.

The optical system according to numerical example 1 is a macro imaging lens with a wide angle, a large diameter, a half angle of view ω of approximately 44°, an F-number of approximately 2.8, and an imaging magnification β of approximately −1.0 in an in-focus state at the closest distance.

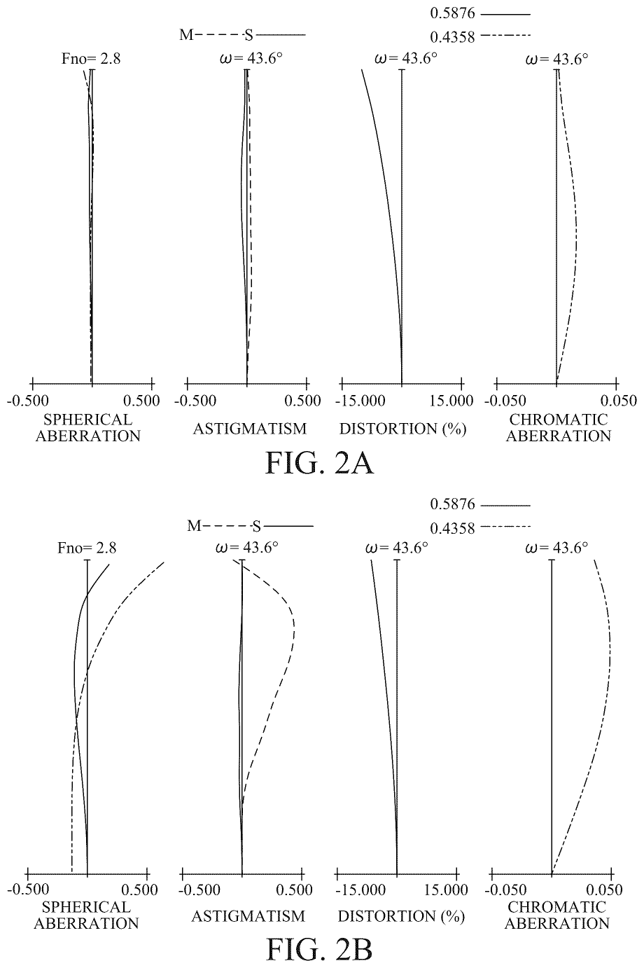

FIG. 2A illustrates the longitudinal aberration (spherical aberration, astigmatism, distortion, and chromatic aberration) of the optical system according to numerical example 1 in an in-focus state at infinity. FIG. 2B illustrates the longitudinal aberration of the optical system according to numerical example 1 in an in-focus state at the closest distance. In the spherical aberration diagram, Fno indicates an F-number. A solid line indicates a spherical aberration amount for the d-line (with a wavelength of 587.6 nm), and an alternate long and two short dashes line indicates a spherical aberration amount for the g-line (with a wavelength of 435.8 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. A chromatic aberration diagram illustrates a lateral chromatic aberration amount for the g-line. ω is an half angle of view (°). A description of these aberration diagrams are similarly applicable to the other numerical examples.

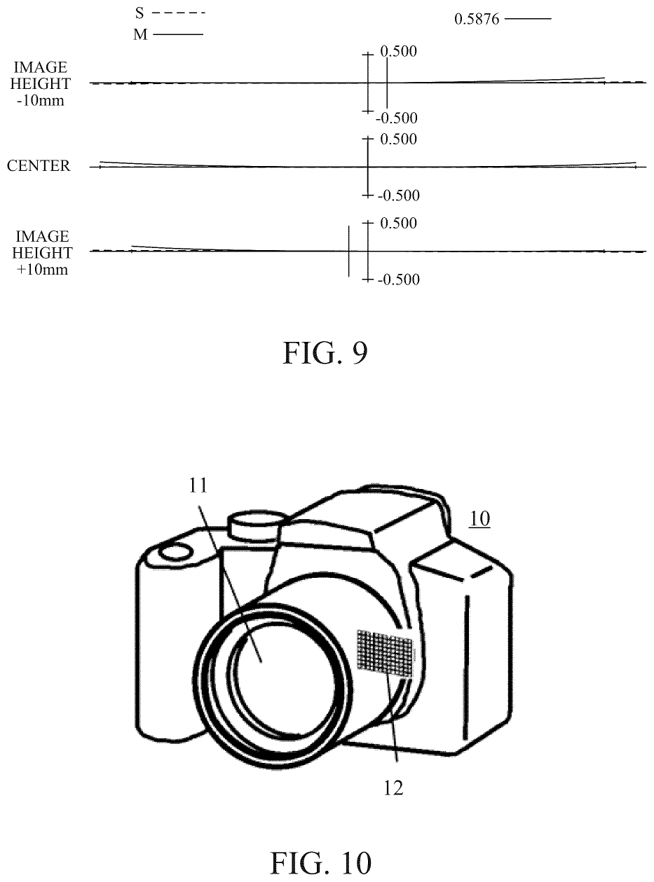

FIG. 9 illustrates the lateral aberration of the optical system according to numerical example 1 when the shift lens Bs is shifted at an angle of a paraxial ray from the optical axis to correct image blur of about 0.3°. FIG. 9 illustrates an aberration change at the center position on the image plane and at positions 10 mm above and below (±) in the image height direction.

### EXAMPLE 2

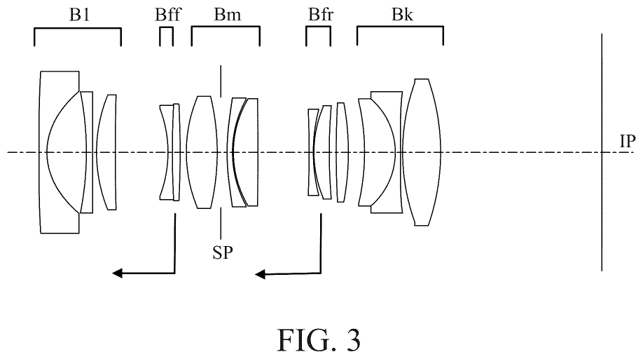

An optical system according to Example 2 (numerical example 2) illustrated in FIG. 3 includes, in order from the object side to the image side, a front lens unit (first lens unit) B1 with negative refractive power, a first focus unit (second lens unit) Bff with negative refractive power, an intermediate lens unit (third lens unit) Bm with positive refractive power, a second focus unit (fourth lens unit) Bfr with negative refractive power, and a rear lens unit (fifth lens unit) Bk with positive refractive power. During focusing from infinity to the closest distance, both the first focus unit Bff and the second focus unit Bfr move toward the object side, as illustrated by arrows in FIG. 3.

The optical system according to numerical example 2 is a macro imaging lens with a wide angle, a large diameter, a half angle of view ω of about 42°, an F-number of about 2.8, and an imaging magnification β of about −1.0 in an in-focus state at the closest distance.

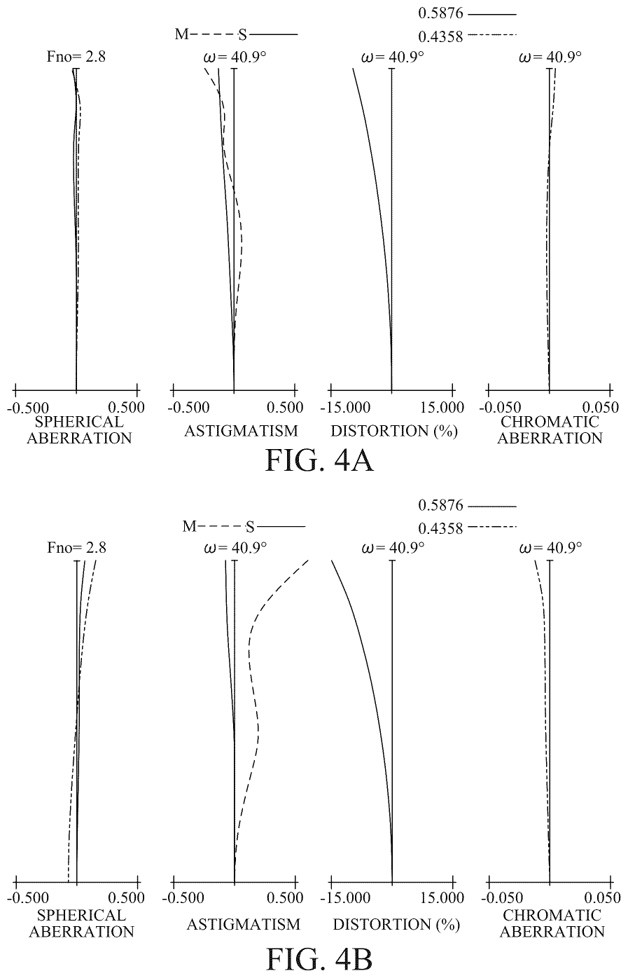

FIG. 4A illustrates the longitudinal aberration of the optical system according to numerical example 2 in the in-focus state at infinity. FIG. 4B illustrates the longitudinal aberration of the optical system according to numerical example 2 in an in-focus state at the closest distance.

### EXAMPLE 3

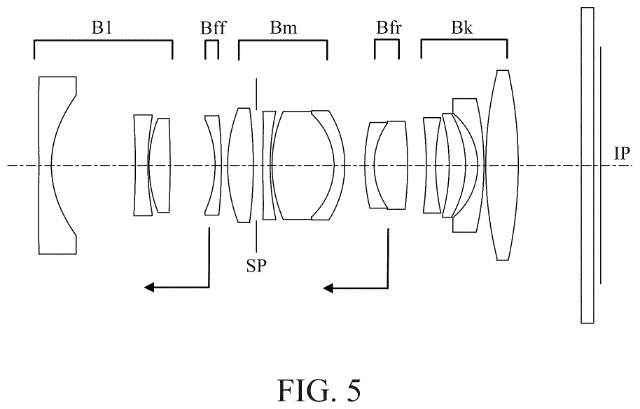

An optical system according to Example 3 (numerical example 3) illustrated in FIG. 5 includes, in order from the object side to the image side, a front lens unit (first lens unit) B1 with negative refractive power, a first focus (second lens unit) Bff with negative refractive power, an intermediate lens unit (third lens unit) Bm with positive refractive power, a second focus unit (fourth lens unit) Bfr with positive refractive power, and a rear lens unit (fifth lens unit) Bk with negative refractive power. During focusing from infinity to the closest distance, both the first focus unit Bff and the second focus unit Bfr move toward the object side, as illustrated by arrows in FIG. 5.

The optical system according to numerical example 3 is a macro imaging lens with a wide angle, a large diameter, a half angle of view ω of about 39°, an F-number of about 2.8, and an imaging magnification β of about −1.2 in an in-focus state at the closest distance.

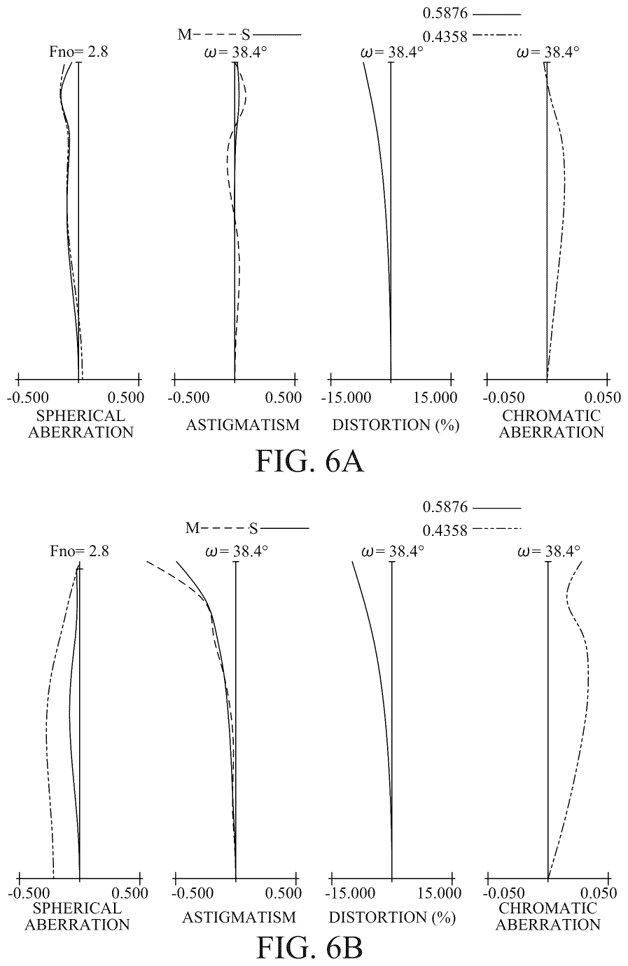

FIG. 6A illustrates the longitudinal aberration of the optical system according to numerical example 3 in an in-focus state at infinity. FIG. 6B illustrates the longitudinal aberration of the optical system according to numerical example 3in an in-focus state at the closest distance.

### EXAMPLE 4

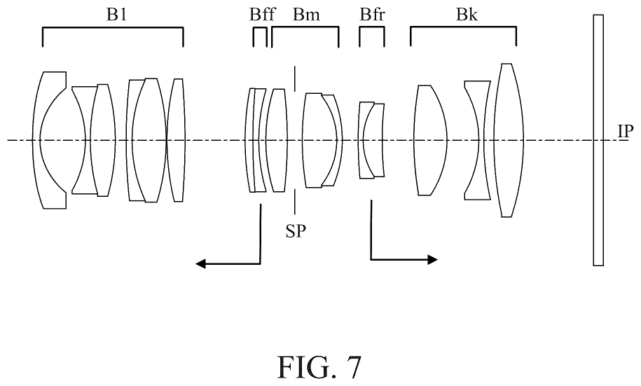

An optical system according to Example 4 (numerical example 4) illustrated in FIG. 7 includes, in order from the object side to the image side, a front lens unit (first lens unit) B1 with positive refractive power, a first focus unit (second lens unit) Bff with negative refractive power, an intermediate lens unit (third lens unit) Bm with positive refractive power, a second focus unit (fourth lens unit) Bfr with negative refractive power, and a rear lens unit (fifth lens unit) Bk with positive refractive power. During focusing from infinity to the closest distance, the first focus unit Bff and the second focus unit Bfr move toward the object side and the image side, respectively, as indicated by arrows in FIG. 7.

The optical system according to numerical example 4 is a macro imaging lens with a wide angle, a large diameter, a half-angle of view ω of approximately 44°, an F-number of approximately 2.8, and an imaging magnification β of approximately −1.2 in an in-focus state at the closest distance.

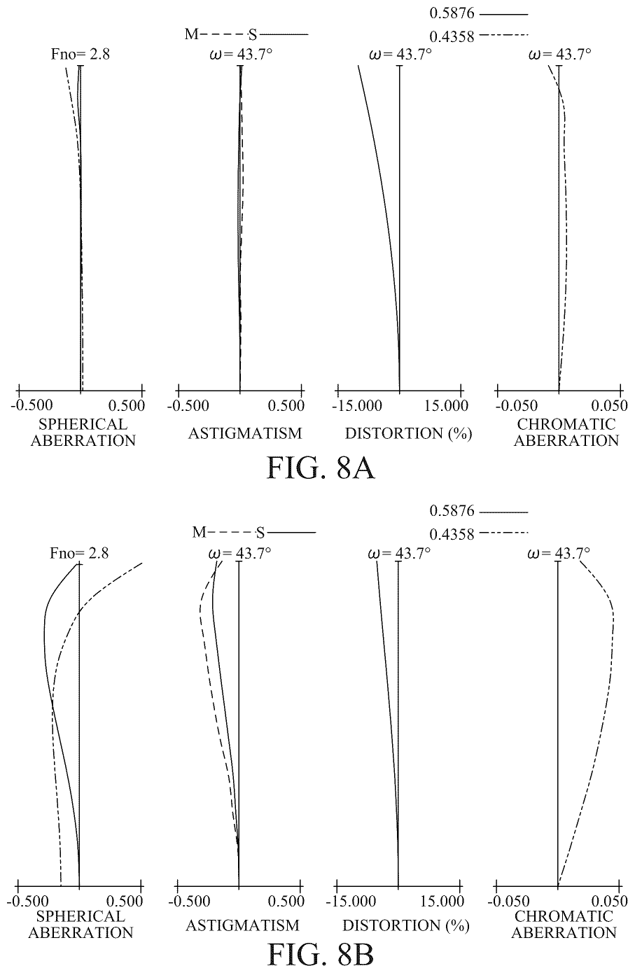

FIG. 8A illustrates the longitudinal aberration of the optical system according to numerical example 4 in an in-focus state at infinity. FIG. 8B illustrates the longitudinal aberration of the optical system according to numerical example 4 in an in-focus state at the closest distance.

### NUMERICAL EXAMPLE 1

### UNIT: mm

SURFACE DATA

| Surface No. | r | d | nd | νd |
|---|---|---|---|---|
| 1* | 91.974 | 1.50 | 1.85400 | 40.4 |
| 2* | 13.412 | 9.12 | | |
| 3 | −22.593 | 1.20 | 1.95375 | 32.3 |
| 4 | −474.273 | 3.67 | 1.59270 | 35.3 |
| 5 | −35.125 | 0.20 | | |
| 6 | 63.572 | 1.20 | 1.95375 | 32.3 |
| 7 | 17.804 | 7.22 | 1.73037 | 32.2 |
| 8 | −81.098 | 2.63 | | |
| 9 | 36.135 | 3.41 | 1.92286 | 20.9 |
| 10 | 602.792 | (Variable) | | |
| 11 | 227.269 | 1.00 | 1.84666 | 23.8 |
| 12 | 40.035 | (Variable) | | |
| 13* | 31.456 | 4.82 | 1.58313 | 59.4 |
| 14 | −55.834 | 1.50 | | |
| 15 (SP) | 00 | 1.50 | | |
| 16 | 71.801 | 7.17 | 1.49700 | 81.5 |
| 17 | −12.824 | 1.46 | 2.00100 | 29.1 |
| 18 | −22.731 | (Variable) | | |
| 19 | 57.479 | 1.00 | 1.61800 | 63.4 |
| 20 | 12.223 | 3.19 | 1.49700 | 81.5 |
| 21 | 25.103 | (Variable) | | |
| 22* | −3097.967 | 6.24 | 1.58313 | 59.4 |
| 23 | −19.131 | 10.19 | | |
| 24 | −23.488 | 1.20 | 2.00100 | 29.1 |
| 25 | −1016.452 | 0.20 | | |
| 26 | 102.877 | 4.64 | 1.84666 | 23.8 |
| 27 | −63.033 | 14.72 | | |
| 28 | ∞ | 2.00 | 1.51633 | 64.1 |
| 29 | ∞ | 1.09 | | |
| Image Plane | ∞ | | | |

SURFACE DISTANCE

| | IN-FOCUS STATE AT INFINITY | β = −1.0 |
|---|---|---|
| 10th Surface | 9.91 | 1.50 |
| 12th Surface | 1.11 | 9.52 |
| 18th Surface | 3.20 | 8.75 |
| 21st Surface | 9.35 | 3.80 |

### ASPHERIC DATA

1st Surface

K=0.00000e+00 A 4=2.14517e-05 A 6=−3.78053e-08 A 8=−4.66959e-11 A10=3.13496e-13

2nd Surface

K=0.00000e+00 A 4=−1.18205e-05 A 6=−9.65940e-08 A 8=2.70156e-10 A10=−8.80968e-12

13th Surface

K=0.00000e+00 A 4=−2.95785e-06 A 6=5.64931e-08 A 8=2.04301e-10 A10=7.35767e-13

22nd Surface

K=0.00000e+00 A4=−1.22787e-05 A6=1.55870e-08 A 8=1.02243e-10

VARIOUS DATA

| | |
|---|---|
| f | 21.00 |
| Fno | 2.80 |
| Half Angle of View (°) | 43.60 |
| Image Height | 20.00 |
| Overall Lens Length | 116.37 |
| sk | 17.14 |

### NUMERICAL EXAMPLE 2

### UNIT: mm

SURFACE DATA

| Surface No. | r | d | nd | νd |
|---|---|---|---|---|
| 1* | −99695.669 | 1.27 | 1.59379 | 69.6 |
| 2* | 10.171 | 6.31 | | |
| 3 | −48.929 | 0.98 | 1.43875 | 94.9 |
| 4 | 1421.039 | 0.64 | | |
| 5 | 23.876 | 3.01 | 1.56840 | 63.3 |
| 6 | 352.054 | (Variable) | | |
| 7 | −19.363 | 0.70 | 1.72381 | 55.2 |
| 8 | 139.133 | 1.24 | 1.83873 | 24.1 |
| 9 | −156.496 | (Variable) | | |
| 10 | 22.725 | 4.95 | 1.61023 | 67.7 |
| 11 | −37.363 | 0.57 | | |
| 12 (SP) | 00 | 1.00 | | |
| 13* | 35.186 | 0.87 | 1.76312 | 33.6 |
| 14 | 17.380 | 0.15 | | |
| 15 | 16.589 | 3.90 | 1.72017 | 55.5 |
| 16 | −1414.625 | (Variable) | | |
| 17 | −150.733 | 0.66 | 1.77790 | 36.5 |
| 18 | 26.937 | 0.10 | | |
| 19 | 18.322 | 2.45 | 1.53528 | 77.4 |
| 20 | 83.476 | (Variable) | | |
| 21 | 144.296 | 1.94 | 1.72536 | 55.0 |
| 22 | −42.603 | 2.59 | | |
| 23 | −35.529 | 4.92 | 1.79065 | 26.0 |
| 24 | −11.195 | 0.83 | 1.91616 | 31.6 |
| 25* | −870.412 | 0.34 | | |
| 26 | 32.338 | 6.08 | 1.43875 | 94.9 |
| 27 | −34.929 | 25.78 | | |
| Image Plane | ∞ | | | |

SURFACE DISTANCE

| | IN-FOCUS STATE AT INFINITY | β = −1.0 |
|---|---|---|
| 7th Surface | 8.42 | 2.38 |
| 10th Surface | 0.99 | 7.04 |
| 17th Surface | 8.21 | 2.17 |
| 21st Surface | 1.11 | 7.15 |

### ASPHERIC DATA

1st Surface

K=0.00000e+00 A 4=2.26030e-05 A 6=−1.33022e-07 A 8=4.524409e-10 A10=5.76179e-13

2nd Surface

K=−1.15870e+00 A 4=7.33037e-05 A 6=1.98964e-07 A 8=−3.11894e-09 A10=1.74666e-11

13th Surface

K=0.00000e+00 A 4=−3.51798e-05 A 6=−5.95737e-08 A 8=−5.56655e-10 A10=2.81885e-13

25th Surface

K=0.00000e+00 A4=3.77972e-05 A 6=3.44816e-08 A 8=3.26135e-10

VARIOUS DATA

| | |
|---|---|
| f | 21.00 |
| Fno | 2.80 |
| Half Angle of View (°) | 40.91 |
| Image Height | 18.20 |
| Overall Lens Length | 90.00 |
| sk | 25.78 |

### NUMERICAL EXAMPLE 3

### UNIT: mm

SURFACE DATA

| Surface No. | r | d | nd | νd |
|---|---|---|---|---|
| 1* | −216.033 | 2.00 | 1.60300 | 65.5 |
| 2* | 16.469 | 13.45 | | |
| 3 | −140.410 | 2.00 | 1.83500 | 43.0 |
| 4 | 42.899 | 0.20 | | |
| 5 | 19.915 | 3.40 | 1.63636 | 35.4 |
| 6 | −138.375 | (Variable) | | |
| 7 | −17.356 | 1.00 | 1.92250 | 36.0 |
| 8 | −75.181 | (Variable) | | |
| 9 | 24.908 | 4.13 | 2.00330 | 28.3 |
| 10 | −69.572 | 0.50 | | |
| 11 (SP) | 00 | 1.00 | | |
| 12* | 103.012 | 1.20 | 2.00330 | 28.3 |
| 13 | 40.999 | 0.30 | | |
| 14 | 21.304 | 9.93 | 1.49700 | 81.6 |
| 15 | −11.030 | 1.72 | 1.95375 | 32.3 |
| 16 | −15.940 | (Variable) | | |
| 17 | 28.523 | 1.50 | 2.00069 | 25.5 |
| 18 | 11.629 | 5.36 | 1.64000 | 60.2 |
| 19 | −59.569 | (Variable) | | |
| 20* | −58.105 | 1.50 | 1.92250 | 36.0 |
| 21 | 35.176 | 2.17 | | |
| 22 | −29.259 | 2.61 | 1.92286 | 20.9 |
| 23 | −16.016 | 1.95 | | |
| 24 | −10.609 | 1.00 | 1.88300 | 40.8 |
| 25 | −45.661 | 0.30 | | |
| 26 | 61.135 | 5.21 | 1.96300 | 24.1 |
| 27 | −71.423 | 10.08 | | |
| 28 | ∞ | 2.00 | 1.51633 | 64.1 |
| 29 | ∞ | 1.11 | | |
| Image Plane | ∞ | | | |

SURFACE DISTANCE

| | IN−FOCUS STATE AT INFINITY | β = −1.2 |
|---|---|---|
| 6th Surface | 7.19 | 4.77 |
| 8th Surface | 1.00 | 3.42 |
| 16th Surface | 3.20 | 1.20 |
| 19th Surface | 3.00 | 5.00 |

### ASPHERIC DATA

1st Surface

K=0.00000e+00 A4=3.30712e-05 A 6=−1.87196e-07 A 8=5.21628e-10 A10=−5.40728e-13

2nd Surface

K=−3.01956e-01 A4=1.15321e-05 A6=−1.02655e-07 A 8=-1.21336e-09A10=4.82736e-12

12th Surface

K=0.00000e+00 A 4=−5.91935e-05 A 6=−8.66204e-08 A 8=3.64043e-1 0A10=6.15794e-12

20th Surface

K=0.00000e+00 A 4=−7.94163e-06 A 6=1.52938e-07 A 8=−1.28541e-09

VARIOUS DATA

| | |
|---|---|
| f | 23.00 |
| Fno | 2.80 |
| Half Angle of View (°) | 38.35 |
| Image Height | 18.20 |
| Overall Lens Length | 89.33 |
| sk | 12.51 |

### NUMERICAL EXAMPLE 4

### UNIT: mm

SURFACE DATA

| Surface No. | r | d | nd | νd |
|---|---|---|---|---|
| 1* | 52.912 | 1.50 | 1.85400 | 40.4 |
| 2* | 12.359 | 9.14 | | |
| 3 | −20.143 | 1.00 | 2.05090 | 26.9 |
| 4 | 39.583 | 5.03 | 1.73037 | 32.2 |
| 5 | −41.488 | 2.17 | | |
| 6 | 107.435 | 1.20 | 2.00100 | 29.1 |
| 7 | 28.791 | 6.86 | 1.73037 | 32.2 |
| 8 | −41.755 | 0.17 | | |
| 9 | 51.389 | 3.64 | 1.92286 | 20.9 |
| 10 | −141.608 | 12.09 | | |
| 11 | 54.468 | 1.58 | 1.49700 | 81.5 |
| 12 | 122.581 | 1.18 | 1.85478 | 24.8 |
| 13 | 35.896 | 1.41 | | |
| 14* | 34.320 | 4.32 | 1.58313 | 59.4 |
| 15 | −87.170 | 1.50 | | |
| 16 (SP) | | 1.50 | | |
| 17 | 56.568 | 6.95 | 1.49700 | 81.5 |
| 18 | −14.491 | 1.12 | 2.00100 | 29.1 |
| 19 | −24.022 | 3.20 | | |
| 20 | 84.175 | 1.00 | 1.88300 | 40.8 |
| 21 | 12.801 | 3.84 | 1.51742 | 52.4 |
| 22 | 64.729 | 6.36 | | |
| 23* | 60.132 | 6.67 | 1.58313 | 59.4 |
| 24 | −19.746 | 6.41 | | |
| 25 | −20.996 | 1.00 | 2.00100 | 29.1 |
| 26 | 52.617 | 2.03 | | |
| 27 | 70.732 | 5.96 | 1.92286 | 20.9 |
| 28 | −49.070 | 14.08 | | |
| 29 | ∞ | 2.00 | 1.51633 | 64.1 |
| 30 | ∞ | 1.11 | | |
| Image Plane | ∞ | | | |

SURFACE DISTANCE

| | IN−FOCUS STATE AT INFINITY | β = −1.0 |
|---|---|---|
| 10th Surface | 12.09 | 1.50 |
| 13th Surface | 1.41 | 12.00 |
| 19th Surface | 3.20 | 8.36 |
| 22nd Surface | 6.36 | 1.20 |

### ASPHERIC DATA

1st Surface

K=0.00000e+00 A 4=1.01124e-05 A 6=2.46220e-08 A 8=−2.13800e-10 A10=7.54306e-13

2nd Surface

K=0.00000e+00 A 4=−2.25419e-05 A 6=−9.42665e-08 A 8=1.75807e-10A10=−1.04562e-11

14th Surface

K=0.00000e+00 A 4=−4.28045e-06 A 6=2.52685e-08 A 8=8.86186e-11 A10=6.51757e-13

23rd Surface

K=0.00000e+00 A 4=−6.60563e-06 A 6=4.67801e-08 A 8=−4.30325e-11

VARIOUS DATA

| | |
|---|---|
| f | 20.94 |
| Fno | 2.80 |
| Half Angle of View (°) | 43.69 |
| Image Height | 20.00 |
| Overall Lens Length | 115.33 |
| sk | 16.51 |

### Image Pickup Apparatus

FIG. 10 illustrates a schematic configuration of an image pickup apparatus (digital still camera) that uses the optical system according to any one of Examples 1 to 4 as the imaging optical system. Reference numeral 10 denotes a camera body, and reference numeral 11 denotes an imaging optical system as any of the optical systems according to Examples 1 to 4.

Reference numeral 12 denotes an image sensor (photoelectric conversion element) such as a CCD sensor or CMOS sensor that is built into the camera body 10 and captures an object image formed by the imaging optical system 11 (i.e., an object through the imaging optical system 11).

The optical system according to any one of Examples 1 to 4 as the imaging optical system 11 can achieve good macro imaging and other wide-angle imaging.

The camera body 10 may be of the lens-interchangeable type or the lens-integrated type, and may further be a single-lens reflex type with a quick-return mirror, or a mirrorless type without a quick-return mirror.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system that has a reduced size, a wide angle, a high image magnification, and high optical performance, and can support autofocus.

This application claims priority to Japanese Patent Application No. 2024-019947, which was filed on Feb. 14, 2024, and which is hereby incorporated by reference herein in its entirety.

What is claimed is:

1. An optical system comprising:
a front lens unit;
a first focus lens unit disposed on an image side of the front lens unit; and
a second focus lens unit disposed on the image side of the first focus lens unit,
wherein a distance between adjacent lens units changes during focusing,
wherein the front lens unit includes two or more negative lenses,
wherein for focusing, the front lens unit does not move, but the first focus lens unit and the second focus lens unit move,
wherein the optical system can provide focusing from an in-focus state on an object at infinity to an in-focus state in which lateral magnification β of the optical system is −1.0 or less, and wherein the following inequality is satisfied:
$$- 5.5 \; 00 \leq \vert ffr \vert / f 1 \leq 0.380$$
where f1 is a focal length of the front lens unit, and ffr is a focal length of at least one of the first focus lens unit and the second focus lens unit.

2. The optical system according to claim 1, wherein the following inequality is satisfied:
$$- 1.5 \leq \vert dltf \vert / d 1 \leq 0.8$$
where dltf is a moving amount of the first focus lens unit during focusing from infinity to a closest distance, and d1 is a length on an optical axis from a surface closest to an object of the front lens unit to a surface closest to an image plane of the front lens.

3. The optical system according to claim 1, wherein the following inequality is satisfied:
$$1. 3 \; 40 \leq \vert ff \vert / f \leq 6.370$$
where ff is a focal length of the first focus lens unit, and f is a focal length of the optical system in the in-focus state on the object at infinity.

4. The optical system according to claim 1, wherein the following inequality is satisfied:
$$0.06 \leq \vert d ltr \vert / d 1 \leq 2.$$
wherein dltr is a moving amount of the second focus lens unit during focusing from infinity to the closest distance.

5. The optical system according to claim 1, wherein the following inequality is satisfied:
$$0.02 \leq df / f \leq 0.4$$
where df is a length on an optical axis from a surface closest to the object of the first focus lens unit to a surface closest to an image plane of the first focus lens unit, and fis a focal length of the optical system in the in-focus state on the object at infinity.

6. The optical system according to claim 1, wherein the following inequality is satisfied:
$$0.09 \leq dr / f \leq 0.500$$
where dr is a length on an optical axis from a surface closest to the object of the second focus lens unit to a surface closest to an image plane of the second focus lens unit, and f is a focal length of the optical system in the in-focus state on the object at infinity.

7. The optical system according to claim 1, wherein the following inequality is satisfied:
$$0.66 \leq \vert f 1 \vert / sk \leq 23.100$$
where sk is an air-equivalent distance on an optical axis from a surface closest to the image plane of the optical system to an image plane.

8. The optical system according to claim 1, wherein the following inequality is satisfied:
$$- 3.2 \leq \vert ff \vert / \vert fr \vert \leq 1.7$$
where ff is a focal length of the first focus lens unit, and fr is a focal length of the second focus lens unit.

9. The optical system according to claim 1, further comprising an intermediate lens unit that does not move for focusing and is provided between the first focus lens unit and the second focus lens unit, and
wherein the intermediate lens unit includes an aperture stop and an aspheric lens, and has positive refractive power as a whole.

10. The optical system according to claim 9, wherein the following inequality is satisfied:
$$0.05 \leq fm / \vert f 1 \vert \leq 1.$$
where fm is a focal length of the intermediate lens unit.

11. The optical system according to claim 9, wherein the following inequality is satisfied:
$$0.44 \leq fm / f \leq 8.4$$
where fm is a focal length of the intermediate lens unit, and fis a focal length of the optical system in the in-focus state on the object at infinity.

12. The optical system according to claim 9, wherein the following inequality is satisfied:
$$0.120 \leq fm / \vert fr \vert \leq 0. 800$$
where fm is a focal length of the intermediate lens unit, and fr is a focal length of the second focus lens unit.

13. The optical system according to claim 1, further comprising a rear lens unit that is disposed on the image side of the second focus lens unit and does not move for focusing,
wherein the rear lens unit has positive or negative refractive power and includes an aspheric lens.

14. The optical system according to claim 13, wherein the following inequality is satisfied:
$$0.1 \; 50 \leq \vert fk \vert / \vert f 1 \vert \leq 6. 900$$
where fk is a focal length of the rear lens unit.

15. The optical system according to claim 13, wherein the following inequality is satisfied:
$$0.49 \leq \vert fk \vert / f \leq 4.500$$
where fk is a focal length of the rear lens unit, and fis a focal length of the optical system in the in-focus state on the object at infinity.

16. The optical system according to claim 13, wherein the following inequality is satisfied:
$$0.61 \leq \vert fk \vert / \vert ff \vert \leq 4.$$
where fk is a focal length of the rear lens unit, and ff is a focal length of the second focus lens unit.

17. The optical system according to claim 1, wherein the front lens unit has negative refractive power,
wherein the first focus lens unit has negative refractive power, and
wherein the second focus lens unit has negative refractive power.

18. The optical system according to claim 1, wherein the front lens unit has negative refractive power,
wherein the first focus lens unit has negative refractive power, and
wherein the second focus lens unit has positive refractive power.

19. The optical system according to claim 1, wherein the front lens unit has positive refractive power,
wherein the first focus lens unit has negative refractive power, and
wherein the second focus lens unit has negative refractive power.

20. An image pickup apparatus comprising:
an optical system; and
an image sensor configured to capture an image of an object through the optical system,
wherein the optical system includes:
a front lens unit;
a first focus lens unit disposed on an image side of the front lens unit; and
a second focus lens unit disposed on the image side of the first focus lens unit,
wherein a distance between adjacent lens units changes during focusing,
wherein the front lens unit includes two or more negative lenses,
wherein for focusing, the front lens unit does not move, but the first focus lens unit and the second focus lens unit move,
wherein the optical system can provide focusing from an in-focus state on an object at infinity to an in-focus state in which lateral magnification β of the optical system is −1.0 or less, and
wherein the following inequality is satisfied:
$$- 5.5 \; 00 \leq \vert ffr \vert / f 1 \leq 0.380$$
where f1 is a focal length of the front lens unit, and ffr is a focal length of at least one of the first focus lens unit and the second focus lens unit.
